(19) United States
(12) Patent Application Publication
(10) Pub. No.: US 2022/0309995 A1
(43) Pub. Date: Sep. 29, 2022

(54) BACKLIGHT CONSTANT CURRENT CONTROL CIRCUIT AND BACKLIGHT STRUCTURE

(71) Applicant: TCL CHINA STAR OPTOELECTRONICS TECHNOLOGY CO., LTD., Shenzhen, GD (CN)

(72) Inventor: Jinfeng LIU, Shenzhen (CN)

(21) Appl. No.: 17/252,018

(22) PCT Filed: Nov. 30, 2020
(86) PCT No.: PCT/CN2020/132608

§ 371 Date: Dec. 14, 2020

(30) Foreign Application Priority Data
Oct. 16, 2020 (CN) 202011110805.3

(51) Int. Cl. G09G 3/32; G09G 3/34

(52) U.S. Cl. CPC G09G 3/32; G09G 3/3406; G09G 2320/0219; G09G 2310/0267; G09G 2320/0233; G09G 2300/0426; G09G 2300/0809

(57) ABSTRACT

A backlight constant current control circuit and a backlight structure are disclosed. The backlight constant current control circuit and the backlight structure include a light-emitting module and a constant current control module. The constant current control module includes a feedback unit connected to an output end of the light-emitting module and a voltage regulating unit connected to an input end of the light-emitting module. When a working current of the light-emitting module deviates from a preset current, the feedback unit outputs a voltage regulation signal to the voltage regulating unit, and the voltage regulating unit adjusts a voltage of the input end of the light-emitting module according to the voltage regulation signal to make the working current the preset current.

### FIELD OF INVENTION

The present disclosure relates to the field of display technologies and particularly to the field of display driving technologies, relating specifically to a backlight constant current control circuit and a backlight structure.

### BACKGROUND OF INVENTION

With vigorous development of information-based society and increasingly mature driving technologies of panel industry, opportunities and challenges also follow. Due to limitations of liquid crystal display (LCD) backlights, such as high power consumption and low contrast, the backlights are forced to develop in a direction of local dimming.

With development of technologies, mini light-emitting diodes (Mini LEDs) with ultra-small process structures have been produced in small batches. Because of small structures, the mini LEDs can realize more partitions. Compared with conventional LCD display technologies, mini LED backlights have more backlight partitions, which makes television image quality more refined, energy consumption lower, images more detailed and contrast more obvious.

A conventional mini LED backlight adopts an active matrix driving scheme to achieve a local dimming backlight. Each partition is composed of a plurality of LED lights connected in series, and each partition is driven by a constant voltage control mode (i.e., a VDD voltage is fixed). When one of the LED lights in a circuit is short-circuited, total resistance of an LED light string in the partition becomes smaller. Because a voltage between both ends of the LED light string remains unchanged, a current of the LED light string in the partition is increased. However, LED lights are extremely sensitive to current, so a display luminosity of the partition will be greater than that of other partitions, or greater than a required luminosity, resulting in uneven luminosity across a backlight, which greatly affects a display effect.

### SUMMARY

The present disclosure provides a backlight constant current control circuit and a backlight structure. Through performing constant current control on a light-emitting module, a short-circuit of a certain device in the light-emitting module can be avoided to affect a current of the light-emitting module, which is conducive to keeping the current of the light-emitting module as a preset current and keeping a luminosity of the light-emitting module at a preset luminosity, so as to ensure stability and uniform distribution of a backlight luminosity, and improve a display effect.

In a first aspect, the present disclosure provides a backlight constant current control circuit. The backlight constant current control circuit includes a light-emitting module and a constant current control module;

the constant current control module includes a voltage regulating unit and a feedback unit which are electrically connected to each other;

the feedback unit is electrically connected to an output end of the light-emitting module, and is configured to output a voltage regulation signal to the voltage regulating unit when a working current of the light-emitting module deviates from a preset current; and

the voltage regulating unit is electrically connected to an input end of the light-emitting module, and is configured to adjust a voltage of the input end of the light-emitting module according to the voltage regulation signal, so as to adjust the working current of the light-emitting module to the preset current and keep a luminosity of the light-emitting module at a preset luminosity.

In the backlight constant current control circuit provided by the present disclosure, the feedback unit includes a sampling unit and a control unit;

the control unit is configured to detect a voltage between both ends of the sampling unit, determine that the working current of the light-emitting module deviates from the preset current when detecting that the voltage between both ends of the sampling unit deviates from a preset voltage, and output the voltage regulation signal to the voltage regulating unit.

In the backlight constant current control circuit provided by the present disclosure, the control unit includes a comparator and a pulse width modulator (PWM) controller, and the voltage regulation signal includes a duty cycle signal;

the comparator is configured to detect the voltage between both ends of the sampling unit, compare the voltage between both ends of the sampling unit with the preset voltage, determine that the working current of the light-emitting module deviates from the preset current when the voltage between both ends of the sampling unit deviates from the preset voltage, and output a level signal to the PWM controller according to a degree of deviation; and

the PWM controller is configured to output the duty cycle signal to the voltage regulating unit according to the level signal.

In the backlight constant current control circuit provided by the present disclosure, the sampling unit includes a sampling resistor, one end of the sampling resistor is electrically connected to the output end of the light-emitting module, and another end of the sampling resistor is grounded; and an input end of the comparator is electrically connected to the output end of the light-emitting module, an output end of the comparator is electrically connected to an input end of the PWM controller, and an output end of the PWM controller is electrically connected to the voltage regulating unit.

In the backlight constant current control circuit provided by the present disclosure, the voltage regulating unit includes a charge-discharge unit, a first switch unit, and a second switch unit;

the voltage regulating unit is configured to control a conduction time of the first switch unit and a conduction time of the second switch unit according to the voltage regulation signal; the charge-discharge unit is charged when the first switch unit is reconnected, and the charge-discharge unit is discharged when the second switch unit is reconnected, so as to adjust the voltage of the input end of the light-emitting module.

In the backlight constant current control circuit provided by the present disclosure, the voltage regulating unit further includes a driver;

the charge-discharge unit is respectively electrically connected to the first switch unit and the second switch unit, and the second switch unit is further electrically connected to the input end of the light-emitting module; and

the driver is respectively electrically connected to the feedback unit, the first switch unit, and the second switch unit, and configured to control the conduction time of the first switch unit and the conduction time of the second switch unit according to the voltage regulation signal.

In the backlight constant current control circuit provided by the present disclosure, the charge-discharge unit includes an inductor, the first switch unit includes a first transistor, and the second switch unit includes a second transistor;

one end of the inductor is provided with an input voltage, and another end of the inductor is electrically connected to a drain electrode of the first transistor and a source electrode of the second transistor; a source electrode of the first transistor is grounded, and a drain electrode of the second transistor is electrically connected to the input end of the light-emitting module; and

an input end of the driver is electrically connected to the feedback unit, and an output end of the driver is electrically connected to a gate electrode of the first transistor and a gate electrode of the second transistor respectively.

In the backlight constant current control circuit provided by the present disclosure, the voltage regulating unit further includes a first capacitor and a second capacitor; one end of the first capacitor is electrically connected to an end of the inductor far away from the first transistor, and another end is grounded; and one end of the second capacitor is electrically connected to the input end of the light-emitting module, and another end is grounded.

In the backlight constant current control circuit provided by the present disclosure, the light-emitting module includes a plurality of light-emitting diodes (LEDs) connected in series.

In a second aspect, the present disclosure further provides a backlight structure. The backlight structure includes backlight constant current control circuits. Each of the backlight constant current control circuits includes a light-emitting module and a constant current control module;

the constant current control module includes a voltage regulating unit and a feedback unit which are electrically connected to each other;

the feedback unit is electrically connected to an output end of the light-emitting module, and is configured to output a voltage regulation signal to the voltage regulating unit when a working current of the light-emitting module deviates from a preset current;

the voltage regulating unit is electrically connected to an input end of the light-emitting module, and is configured to adjust a voltage of the input end of the light-emitting module according to the voltage regulation signal, so as to adjust the working current of the light-emitting module to the preset current and keep a luminosity of the light-emitting module at a preset luminosity; and

the backlight structure further includes at least one backlight partition, and the backlight partition is provided with at least one light-emitting module of the backlight constant current control circuit.

In the backlight structure provided by the present disclosure, a plurality of the constant current control modules of the plurality of the backlight constant current control circuits are integrated and disposed in a same control chip.

In the backlight structure provided by the present disclosure, each of the constant current control modules corresponding to the backlight partition is disposed in an independent control chip.

In the backlight structure provided by the present disclosure, the feedback unit includes a sampling unit and a control unit;

the control unit is configured to detect a voltage between both ends of the sampling unit, determine that the working current of the light-emitting module deviates from the preset current when detecting that the voltage between both ends of the sampling unit deviates from a preset voltage, and output the voltage regulation signal to the voltage regulating unit.

In the backlight structure provided by the present disclosure, the control unit includes a comparator and a PWM controller, and the voltage regulation signal includes a duty cycle signal;

the comparator is configured to detect the voltage between both ends of the sampling unit, compare the voltage between both ends of the sampling unit with the preset voltage, determine that the working current of the light-emitting module deviates from the preset current when the voltage between both ends of the sampling unit deviates from the preset voltage, and output a level signal to the PWM controller according to a degree of deviation; and

the PWM controller is configured to output the duty cycle signal to the voltage regulating unit according to the level signal.

In the backlight structure provided by the present disclosure, the sampling unit includes a sampling resistor, one end of the sampling resistor is electrically connected to the output end of the light-emitting module, and another end of the sampling resistor is grounded; an input end of the comparator is electrically connected to the output end of the light-emitting module, an output end of the comparator is electrically connected to an input end of the PWM controller, and an output end of the PWM controller is electrically connected to the voltage regulating unit.

In the backlight structure provided by the present disclosure, the voltage regulating unit includes a charge-discharge unit, a first switch unit, and a second switch unit;

the voltage regulating unit is configured to control a conduction time of the first switch unit and a conduction time of the second switch unit according to the voltage regulation signal; the charge-discharge unit is charged when the first switch unit is reconnected, and the charge-discharge unit is discharged when the second switch unit is reconnected, so as to adjust the voltage of the input end of the light-emitting module.

In the backlight structure provided by the present disclosure, the voltage regulating unit further includes a driver;

the charge-discharge unit is respectively electrically connected to the first switch unit and the second switch unit, and the second switch unit is further electrically connected to the input end of the light-emitting module; and

the driver is respectively electrically connected to the feedback unit, the first switch unit, and the second switch unit, and configured to control the conduction time of the first switch unit and the conduction time of the second switch unit according to the voltage regulation signal.

In the backlight structure provided by the present disclosure, the charge-discharge unit includes an inductor, the first switch unit includes a first transistor, and the second switch unit includes a second transistor;

one end of the inductor is provided with an input voltage, and another end of the inductor is electrically connected to a drain electrode of the first transistor and a source electrode of the second transistor; a source electrode of the first transistor is grounded, and a drain electrode of the second transistor is electrically connected to the input end of the light-emitting module; and

an input end of the driver is electrically connected to the feedback unit, and an output end of the driver is electrically connected to a gate electrode of the first transistor and a gate electrode of the second transistor respectively.

In the backlight structure provided by the present disclosure, the voltage regulating unit further includes a first capacitor and a second capacitor; one end of the first capacitor is electrically connected to an end of the inductor far away from the first transistor, and another end is grounded; and one end of the second capacitor is electrically connected to the input end of the light-emitting module, and another end is grounded.

In the backlight structure provided by the present disclosure, the light-emitting module includes a plurality of LEDs connected in series.

Compared with the prior art, in the backlight constant current control circuit and the backlight structure provided in the present disclosure, the voltage regulating unit and the feedback unit of the constant current control module are respectively electrically connected to the input end of the light-emitting module and the output end of the light-emitting module. When detecting that the working current of the light-emitting module deviates from the preset current, the voltage regulation signal is output to the voltage regulating unit through the feedback unit, and the voltage regulating unit adjusts the voltage of the input end of the light-emitting module according to the voltage regulation signal, so as to adjust the working current of the light-emitting module to the preset current and keep the luminosity of the light-emitting module at the preset luminosity, thus avoiding a problem of uneven luminosity of the backlight structure caused by the current fluctuation of the light-emitting module, which is conducive to maintaining backlight luminosity stability. When the backlight constant current control circuit and the backlight structure are applied to display devices, it is conducive to improving a display effect.

### DESCRIPTION OF DRAWINGS

Following describes specific implementations of the present disclosure in detail with reference to accompanying drawings, which will make the technical solutions and other beneficial effects of the present disclosure obvious.

FIG. 1 is a schematic diagram of a backlight constant current control circuit provided in an embodiment of the present disclosure.

FIG. 2 is a circuit schematic view of the backlight constant current control circuit provided in the embodiment of the present disclosure.

FIG. 3 is a schematic view of a backlight structure provided in an embodiment of the present disclosure.

### DETAILED DESCRIPTION OF EMBODIMENTS

A clearly and completely description of the technical solution will be given in combination with the accompanying drawings in the embodiments of the present disclosure. Obviously, the embodiments described are only a part of embodiments of the present disclosure and not all of them. Based on the embodiment of the present disclosure, all other embodiments obtained by those skilled in the art without making any invention efforts all belong to a protection scope of the present disclosure.

In the description of the present disclosure, it should be understood that, orientational or positional relationships indicated by terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counter-clockwise”, etc. are based on orientational or positional relationships shown in the drawings. These terms are only for convenience describing the present disclosure and simplifying the description, and do not indicate or imply that devices or elements referred to must have specific orientations, be constructed and operate in specific orientations, and therefore cannot be understood as a limitation on present disclosure. In addition, terms such as “first” and “second” are used herein for purposes of description, and should not be interpreted as indicate or imply relative importance or significance. Therefore, features limited by terms such as “first” and “second” can explicitly or impliedly includes one or more than one these features. In the description of the present disclosure, “a plurality of” means two or more than two, unless otherwise specified.

In description of the present disclosure, it should be noted, the terms “install”, “connect”, and “couple” shall be understood broadly, unless otherwise explicitly stated and defined, and may be, for example, a fixed connection, a detachable connection, or an integral connection; a mechanical connection or an electrical connection; directly connected or indirectly connected through an intermediate medium; an internal connection of the two elements. The specific meanings of the above terms in the present disclosure can be understood in the specific circumstances for those skilled in the art.

In the present disclosure, unless specifically stated and defined otherwise, that a first feature is “on” or “under” a second feature may include: the first feature and the second feature are not in direct contact but are contacted by another feature between them. Furthermore, that the first feature is “on”, “above”, or “upon” the second feature includes that the first feature is directly above and obliquely above the second feature, or merely indicates that the first feature is higher in level than the second feature. That the first feature is “under” or “below” the second feature includes that the first feature is directly below and obliquely below the second feature, or merely indicates that the first feature is lower in level than the second feature.

Following disclosure provides various different implementations or examples for implementing different structures of the present disclosure. To simplify the disclosure of the present disclosure, components and settings of specific examples are described below. Of course, they are merely examples and are not intended to limit the present disclosure. In addition, the present disclosure may repeat reference numbers and/or reference letters in different examples, and such repetition is for purpose of simplicity and clarity, and does not indicate relationship between the various embodiments and/or settings discussed. In addition, examples of various specific processes and materials are provided in the present disclosure, but those of ordinary skill in the art may be aware of application of other processes and/or other materials.

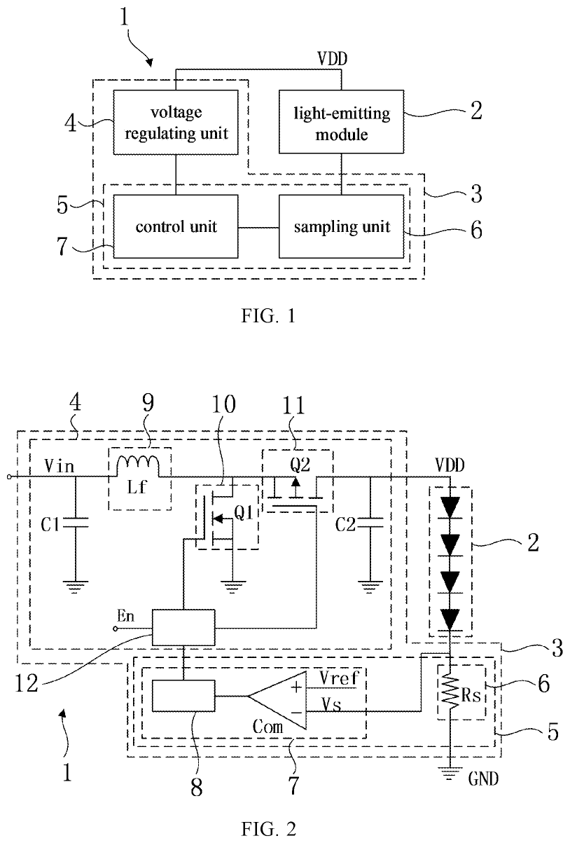

As shown in FIG. 1 and FIG. 2, an embodiment of the present disclosure provides a backlight constant current control circuit 1. The backlight constant current control circuit 1 includes a light-emitting module 2 and a constant current control module 3, which are electrically connected to each other. The constant current control module 3 includes a voltage regulating unit 4 and a feedback unit 5, which are electrically connected to each other. The feedback unit 5 is electrically connected to an output end of the light-emitting module 2, and is configured to output a voltage regulation signal to the voltage regulating unit 4 when a working current of the light-emitting module 2 deviates from a preset current. The voltage regulating unit 4 is electrically connected to an input end of the light-emitting module 2, and is configured to adjust a voltage VDD of the input end of the light-emitting module 2 according to the voltage regulation signal, so as to adjust the working current of the light-emitting module 2 to the preset current and keep a luminosity of the light-emitting module 2 at a preset luminosity.

It can be understood that the VDD in the embodiments of the present disclosure is not a fixed value.

Specifically, in the embodiments of the present disclosure, the luminosity of the light-emitting module 2 is controlled by the working current. Wherein, the working current is an actual current when the light-emitting module 2 emits light, and the preset current is a current that flows through the light-emitting module 2 when the light-emitting module 2 is at the preset luminosity. Therefore, the preset current can be obtained according to the preset luminosity. Since the working current of the light-emitting module 2 changes with a voltage between both ends of the light-emitting module 2, the working current of the light-emitting module 2 can be adjusted by adjusting the voltage VDD of the input end of the light-emitting module 2 to be equal to the preset current.

Specifically, the light-emitting module 2 includes a plurality of light-emitting diodes (LEDs) connected in series, which can be a plurality of mini LEDs connected in series. In this embodiment, four LEDs connected in series are taken as an example for illustration. It can be understood that the input end of the light-emitting module 2 is a positive terminal, and the output end of the light-emitting module 2 is a negative terminal.

The feedback unit 5 includes a sampling unit 6 and a control unit 7. The sampling unit 6 is electrically connected to the output end of the light-emitting module 2. The control unit 7 is electrically connected to the sampling unit 6 and the voltage regulating unit 4 respectively and is configured to detect a voltage Vs between both ends of the sampling unit 6, determine that the working current of the light-emitting module 2 deviates from the preset current when detecting that the voltage Vs between both ends of the sampling unit 6 deviates from a preset voltage Vref, and output the voltage regulation signal to the voltage regulating unit 4.

Specifically, the sampling unit 6 has a fixed resistance value R₀, and the light-emitting module 2 and the sampling unit 6 are connected in series, so a current flowing through the light-emitting module 2 and a current flowing through the sampling unit 6 is the same. Therefore, the working current of the light-emitting module 2 can be obtained according to the voltage Vs between both ends of the sampling unit 6. The preset voltage Vref in the embodiments of the present disclosure is the voltage Vs between both ends of the sampling unit 6 when a current of the sampling unit 6 is the preset current, i.e., the preset voltage Vref=the preset current×R₀. Therefore, the working current and the preset current of the light-emitting module 2 can be compared by comparing the voltage Vs between both ends of the sampling unit 6 with the preset voltage Vref.

Specifically, the control unit 7 includes a comparator (Com) and a pulse width modulator (PWM) controller 8, and the voltage regulation signal includes a duty cycle signal. Wherein, the comparator (Com) is configured to detect the voltage Vs between both ends of the sampling unit 6, compare the voltage Vs between both ends of the sampling unit 6 with the preset voltage Vref, determine that the working current of the light-emitting module 2 deviates from the preset current when the voltage Vs between both ends of the sampling unit 6 deviates from the preset voltage Vref, and output a level signal to the PWM controller 8 according to a degree of deviation. The PWM controller 8 is configured to output the duty cycle signal to the voltage regulating unit 4 according to the level signal.

Specifically, the sampling unit 6 includes a sampling resistor (Rs), one end of the sampling resistor (Rs) is electrically connected to the output end of the light-emitting module 2, and another end of the sampling resistor (Rs) is grounded. An input end of the comparator (Com) is electrically connected to the output end of the light-emitting module 2, an output end of the comparator (Com) is electrically connected to an input end of the PWM controller 8, and an output end of the PWM controller 8 is electrically connected to the voltage regulating unit 4.

Specifically, when the working current of the light-emitting module 2 is positively deviated (greater than) from the preset current, the comparator (Com) outputs a first level signal to the PWM controller 8; when the working current of the light-emitting module 2 is negatively deviated (less than) from the preset current, the comparator (Com) outputs a second level signal to the PWM controller 8; and the PWM controller 8 outputs different duty cycle signals according to the first level signal and the second level signal.

Specifically, the comparator (Com) includes an in-phase input end (+) and an inverting input end (−). When the in-phase input end of the comparator (Com) is electrically connected to the output end of the light-emitting module 2, the inverting input end of the comparator (Com) is provided with the preset voltage Vref. At this time, the in-phase input end of the comparator (Com) receives the voltage Vs between both ends of the sampling resistor (Rs). The voltage Vs between both ends of the sampling resistor (Rs) is compared with the preset voltage Vref, and if the voltage Vs between both ends of the sampling resistor (Rs) is greater than the preset voltage Vref, the comparator (Com) outputs a high-level signal to the PWM controller 8, and if the voltage Vs between both ends of the sampling resistor (Rs) is less than the preset voltage Vref, the comparator (Com) outputs a low-level signal to the PWM controller 8. Of course, when the inverting input end of the comparator (Com) is electrically connected to the output end of the light-emitting module 2, the in-phase input end of the comparator (Com) is provided with the preset voltage Vref. At this time, the inverting input end of the comparator (Com) receives the voltage Vs between both ends of the sampling resistor (Rs). The voltage Vs between both ends of the sampling resistor (Rs) is compared with the preset voltage Vref, and if the voltage Vs between both ends of the sampling resistor (Rs) is greater than the preset voltage Vref, the comparator (Com) outputs a low-level signal to the PWM controller 8, and if the voltage Vs between both ends of the sampling resistor (Rs) is less than the preset voltage Vref, the comparator (Com) outputs a high-level signal to the PWM controller 8.

In an embodiment, the constant current control module 3 may further include a controller. The controller is electrically connected to the input end of the comparator (Com) to output the preset voltage Vref to the comparator (Com). The constant current control module 3 can further include a regulating resistor. One end of the regulating resistor is electrically connected to the controller and another end of the regulating resistor is grounded. The controller can adjust the preset luminosity of the light-emitting module 2 according to a resistance value of the regulating resistor. It can be understood that if the resistance value of the regulating resistor is different, the preset voltage Vref output by the controller is different. Disposing the regulating resistor can make the constant current control module 3 suitable for the light-emitting module 2 with different luminosity requirements, thus increasing the application range.

The voltage regulating unit 4 includes a charge-discharge unit 9, a first switch unit 10, and a second switch unit 11. Wherein, the voltage regulating unit 4 is configured to control a conduction time of the first switch unit 10 and a conduction time of the second switch unit 11 according to the voltage regulation signal. The charge-discharge unit 9 is charged when the first switch unit 10 is reconnected, and the charge-discharge unit 9 is discharged when the second switch unit 11 is reconnected, so as to adjust the voltage VDD of the input end of the light-emitting module 2.

Specifically, the voltage regulating unit 4 further includes a driver 12. The charge-discharge unit 9 is respectively electrically connected to the first switch unit 10 and the second switch unit 11, and the second switch unit 11 is further electrically connected to the input end of the light-emitting module 2. The driver 12 is respectively electrically connected to the feedback unit 5, the first switch unit 10, and the second switch unit 11, and configured to control the conduction time of the first switch unit 10 and the conduction time of the second switch unit 11 according to the voltage regulation signal.

In an embodiment, the charge-discharge unit 9 is an inductor (low-frequency, Lf), the first switch unit 10 is a first transistor Q1, specifically a n-channel metal oxide semiconductor (NMOS) tube, and the second switch unit 11 is a second transistor Q2, specifically a p-channel metal oxide semiconductor (PMOS) tube. One end of the inductor (Lf) is provided with an input voltage (Vin), and another end of the inductor (Lf) is electrically connected to a drain electrode of the first transistor Q1 and a source electrode of the second transistor Q2. A source electrode of the first transistor Q1 is grounded, and a drain electrode of the second transistor Q2 is electrically connected to the input end of the light-emitting module 2. The inductor (Lf) is further configured to raise the input voltage (Vin) and convert the input voltage (Vin) into the voltage VDD of the input end of the light-emitting module 2 by charging and discharging. As the conduction time of the first transistor Q1 and the conduction time of the second transistor Q2 are different, a charging time of the inductor (Lf) and a discharging time of the inductor (Lf) are different, which makes an increasing proportion of the input voltage (Vin) different, so that the voltage VDD of the input end of the light-emitting module 2 can be controlled to be different. An input end of the driver 12 is electrically connected to the feedback unit 5, specifically to the output end of the PWM controller 8. An output end of the driver 12 is electrically connected to a gate electrode of the first transistor Q1 and a gate electrode of the second transistor Q2 respectively. It is understood that the driver 12 controls the conduction time of the first transistor Q1 and the conduction time of the second transistor Q2 according to the duty cycle signal output by the PWM controller 8.

Specifically, the voltage regulating unit 4 further includes a first capacitor C1 and a second capacitor C2. Wherein, one end of the first capacitor C1 is electrically connected to an end of the inductor (Lf) far away from the first transistor Q1, another end of the first capacitor C1 is grounded, and one end of the second capacitor C2 is electrically connected to the input end of the light-emitting module 2, another end of the second capacitor C2 is grounded.

Specifically, another input end of the driver 12 is further provided with an enable signal (En). When the enable signal (En) is at a high level, the driver 12 is in a working state, and when the enabling signal (En) is at a low level, the driver 12 is in an off state. The enable signal (En) can be provided to the driver 12 through a gate drive.

Specifically, a working principle of the voltage regulation unit 4 is: when the driver 12 is provided with the enable signal (En) at the high level, the driver 12 starts to work, the PWM controller 8 outputs the duty cycle signal according to the level signal output by the comparator (Com), and the driver 12 controls the first transistor Q1 and the second transistor Q2 to be reconnected successively according to the duty cycle signal; when the first transistor Q1 is reconnected and the second transistor Q2 is disconnected, the inductor (Lf) is charged, the input voltage (Vin) flows through the inductor (Lf) and a current in the inductor (Lf) increases linearly and proportionally; when the first transistor Q1 is disconnected and the second transistor Q2 is reconnected, the inductor (Lf) is discharged, and the current flowing through the inductor (Lf) flows to the input end of the light-emitting module 2 and charges the second capacitor C2, so that a voltage received by the input end of the light-emitting module 2 is higher than the input voltage (Vin). As the conduction time of the first transistor Q1 and the conduction time of the second transistor Q2 are different, the charging time of the inductor (Lf) and the discharging time of the inductor (Lf) are different, which makes the increasing proportion of the input voltage (Vin) different. Therefore, the increasing proportion of the input voltage (Vin) can be adjusted by adjusting the conduction time of the first transistor Q1 and the conduction time of the second transistor Q2, so as to adjust the voltage VDD of the input end of the light-emitting module 2.

In the backlight constant current control circuit 1 provided in the embodiments of the present disclosure, the constant current control module 3 detects the voltage Vs between both ends of the sampling unit 6 through the feedback unit 5, thus indirectly detecting the working current of the light-emitting module 2, and when detecting that the working current of the light-emitting module 2 deviates from the preset current, the voltage VDD of the input end of the light-emitting module 2 is adjusted by the voltage regulating unit 4, so that the working current of the light-emitting module 2 can be adjusted to be equal to the preset current, so that the luminosity of the light-emitting module 2 can be kept at the preset luminosity, thus avoiding a problem of uneven luminosity of the backlight structure caused by the current fluctuation of the light-emitting module 2, which is conducive to maintaining backlight luminosity stability. When the backlight constant current control circuit 1 is applied to display devices, it is conducive to improving a display effect.

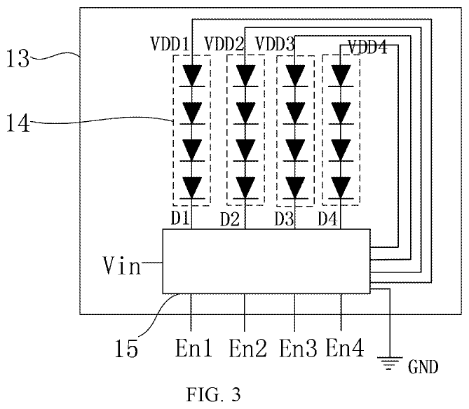

As shown in FIG. 3, the present disclosure further provides a backlight structure 13. The backlight structure 13 includes a plurality of the backlight constant current control circuits provided in the above-mentioned embodiments. The backlight structure 13 further includes at least one backlight partition 14, and each backlight partition 14 is provided with at least one light-emitting module of the backlight constant current control circuit.

Specifically, a plurality of the constant current control modules of the plurality of the backlight constant current control circuits are integrated and disposed in a same control chip 15. At this time, the light-emitting module and connecting lines between the light-emitting module and the control chip 15 are disposed in the backlight partition 14, while the control chip 15 can be disposed in a border area or on a back of the backlight structure 13 to avoid being disposed in the backlight partition 14, and the embodiments of the present disclosure can control the light-emitting modules of multiple partitions through one control chip 15 simply, which can effectively simplify a circuit structure of the backlight partition 14, and is conducive to reducing costs.

Specifically, a first end of the control chip 15 is connected to the input voltage (Vin), a second end of the control chip 15 is connected to the enable signal (En), a third end of the control chip 15 is grounded, fourth ends of the control chip 15 are respectively electrically connected to output ends of the light-emitting modules in a plurality of the backlight partitions 14, and fifth ends of the control chip 15 are respectively electrically connected to input ends of the light-emitting modules in the plurality of the backlight partitions 14. It can be understood that the control chip 15 may be provided with a plurality of second ends, a plurality of the fourth ends, and a plurality of the fifth ends.

As shown in FIG. 3, the embodiments of the present disclosure is illustrated by taking four backlight partitions 14 as examples, in which light-emitting modules D1, D2, D3, and D4 are respectively disposed. The first end of the control chip 15 is provided with an input voltage (Vin), and the third end is grounded. The second ends of the control chip 15 are provided with four enabling signals En1, En2, En3, and En4, wherein, the enabling signals En1, En2, En3, and En4 are configured to control working states of the drivers in four voltage regulating units in the control chip 15, and the four voltage regulating units are respectively configured to adjust voltages VDD1, VDD2, VDD3, and VDD4 of input ends of the light-emitting modules D1, D2, D3, and D4. The fourth ends of the control chip 15 are electrically connected to output ends of the light-emitting modules D1, D2, D3, and D4, and the fifth ends of the control chip 15 are electrically connected to the input ends of the light-emitting modules D1, D2, D3, and D4. The control chip 15 integrates four constant current control modules of four backlight constant current control circuits, so that the four constant current control modules can share one input voltage port and one first capacitor C1, i.e., only one input voltage port and one first capacitor C1 are disposed in the control chip 15, which is conducive to simplifying a structure of the backlight constant current control circuit in the backlight structure 13 and saving costs.

In this embodiment, the constant current control module in the backlight structure 13 performs constant current control on the light-emitting module by adjusting the voltage of the input end of the light-emitting module, thereby avoiding an influence of a working current fluctuation of the light-emitting module due to LEDs short-circuiting. Therefore, the backlight structure 13 can be applied in a liquid crystal display device to provide a backlight with stable luminosity for a liquid crystal display panel, which is conducive to achieving stability and uniform distribution of the backlight luminosity, thereby improving the display effect. Of course, the backlight structure 13 provided in the present disclosure is not limited to applications to liquid crystal display panels. In addition, the plurality of the constant current control modules of the backlight structure 13 are integrated and disposed in the same control chip 15, so that the backlight structure 13 can adjust the luminosity of the light-emitting modules of the plurality of the backlight partitions 14 through one control chip 15, which is conducive to simplifying circuit structures of the backlight partitions 14, simplifying the backlight constant current control circuit, and reducing costs.

An embodiment of the present disclosure further provides a backlight structure. Different from the above-mentioned embodiments, each of the constant current control modules corresponding to the backlight partition is disposed in an independent control chip, i.e., one control chip controls the light-emitting module of a backlight partition.

In the above-mentioned embodiments, description of each embodiment has its own emphasis. For parts not detailed in one embodiment can refer to the relevant description of other embodiments.

The backlight constant current control circuit and the backlight structure provided in the embodiments of the present disclosure has been described in detail above. Specific examples are applied to explain principle and implementation mode of the present disclosure in this paper. The description of the above embodiments is merely used to help understand the technical solution and core idea of the application. The ordinary person skilled in the art shall understand that they can still modify the technical solution recorded in the above embodiments, or replace some of the technical features equally. These modifications or substitutions do not make the nature of the corresponding technical solution deviate from the scope of the technical solution of the embodiments of the present disclosure.

What is claimed is:

1. A backlight constant current control circuit, comprising a light-emitting module and a constant current control module;
wherein the constant current control module comprises a voltage regulating unit and a feedback unit which are electrically connected to each other;
wherein the feedback unit is electrically connected to an output end of the light-emitting module, and is configured to output a voltage regulation signal to the voltage regulating unit when a working current of the light-emitting module deviates from a preset current; and
wherein the voltage regulating unit is electrically connected to an input end of the light-emitting module, and is configured to adjust a voltage of the input end of the light-emitting module according to the voltage regulation signal, so as to adjust the working current of the light-emitting module to the preset current and keep a luminosity of the light-emitting module at a preset luminosity.

2. The backlight constant current control circuit in claim 1, wherein the feedback unit comprises a sampling unit and a control unit;
wherein the control unit is configured to detect a voltage between both ends of the sampling unit, determine that the working current of the light-emitting module deviates from the preset current when detecting that the voltage between both ends of the sampling unit deviates from a preset voltage, and output the voltage regulation signal to the voltage regulating unit.

3. The backlight constant current control circuit in claim 2, wherein the control unit comprises a comparator and a pulse width modulator (PWM) controller, and the voltage regulation signal comprises a duty cycle signal;
wherein the comparator is configured to detect the voltage between both ends of the sampling unit, compare the voltage between both ends of the sampling unit with the preset voltage, determine that the working current of the light-emitting module deviates from the preset current when the voltage between both ends of the sampling unit deviates from the preset voltage, and output a level signal to the PWM controller according to a degree of deviation; and
wherein the PWM controller is configured to output the duty cycle signal to the voltage regulating unit according to the level signal.

4. The backlight constant current control circuit in claim 3, wherein the sampling unit comprises a sampling resistor, one end of the sampling resistor is electrically connected to the output end of the light-emitting module, and another end of the sampling resistor is grounded; and an input end of the comparator is electrically connected to the output end of the light-emitting module, an output end of the comparator is electrically connected to an input end of the PWM controller, and an output end of the PWM controller is electrically connected to the voltage regulating unit.

5. The backlight constant current control circuit in claim 1, wherein the voltage regulating unit comprises a charge-discharge unit, a first switch unit, and a second switch unit;
wherein the voltage regulating unit is configured to control a conduction time of the first switch unit and a conduction time of the second switch unit according to the voltage regulation signal; the charge-discharge unit is charged when the first switch unit is reconnected, and the charge-discharge unit is discharged when the second switch unit is reconnected, so as to adjust the voltage of the input end of the light-emitting module.

6. The backlight constant current control circuit in claim 5, wherein the voltage regulating unit further comprises a driver;
wherein the charge-discharge unit is respectively electrically connected to the first switch unit and the second switch unit, and the second switch unit is further electrically connected to the input end of the light-emitting module; and
wherein the driver is respectively electrically connected to the feedback unit, the first switch unit, and the second switch unit and configured to control the conduction time of the first switch unit and the conduction time of the second switch unit according to the voltage regulation signal.

7. The backlight constant current control circuit in claim 6, wherein the charge-discharge unit comprises an inductor, the first switch unit comprises a first transistor, and the second switch unit comprises a second transistor;
wherein one end of the inductor is provided with an input voltage, and another end of the inductor is electrically connected to a drain electrode of the first transistor and a source electrode of the second transistor; a source electrode of the first transistor is grounded, and a drain electrode of the second transistor is electrically connected to the input end of the light-emitting module; and
wherein an input end of the driver is electrically connected to the feedback unit, and an output end of the driver is electrically connected to a gate electrode of the first transistor and a gate electrode of the second transistor respectively.

8. The backlight constant current control circuit in claim 7, wherein the voltage regulating unit further comprises a first capacitor and a second capacitor; one end of the first capacitor is electrically connected to an end of the inductor far away from the first transistor, and another end is grounded; and one end of the second capacitor is electrically connected to the input end of the light-emitting module, and another end is grounded.

9. The backlight constant current control circuit in claim 1, wherein the light-emitting module comprises a plurality of light-emitting diodes (LEDs) connected in series.

10. A backlight structure, comprising a plurality of the backlight constant current control circuits as claimed in claim 1, wherein the backlight structure comprises at least one backlight partition, and the backlight partition is provided with at least one light-emitting module of the backlight constant current control circuit.

11. The backlight structure in claim 10, wherein a plurality of the constant current control modules of the plurality of the backlight constant current control circuits are integrated and disposed in a same control chip.

12. The backlight structure in claim 10, wherein each of the constant current control modules corresponding to the backlight partition is disposed in an independent control chip.

13. The backlight structure in claim 10, wherein the feedback unit comprises a sampling unit and a control unit;
wherein the control unit is configured to detect a voltage between both ends of the sampling unit, determine that the working current of the light-emitting module deviates from the preset current when detecting that the voltage between both ends of the sampling unit deviates from a preset voltage, and output the voltage regulation signals to the voltage regulating unit.

14. The backlight structure in claim 13, wherein the control unit comprises a comparator and a pulse width modulator (PWM) controller, and the voltage regulation signal comprises a duty cycle signal;
wherein the comparator is configured to detect the voltage between both ends of the sampling unit, compare the voltage between both ends of the sampling unit with the preset voltage, determine that the working current of the light-emitting module deviates from the preset current when the voltage between both ends of the sampling unit deviates from the preset voltage, and output a level signal to the PWM controller according to a degree of deviation; and
wherein the PWM controller is configured to output the duty cycle signal to the voltage regulating unit according to the level signal.

15. The backlight structure in claim 14, wherein the sampling unit comprises a sampling resistor, one end of the sampling resistor is electrically connected to the output end of the light-emitting module, and another end of the sampling resistor is grounded; an input end of the comparator is electrically connected to the output end of the light-emitting module, an output end of the comparator is electrically connected to an input end of the PWM controller, and an output end of the PWM controller is electrically connected to the voltage regulating unit.

16. The backlight structure in claim 10, wherein the voltage regulating unit comprises a charge-discharge unit, a first switch unit, and a second switch unit;
wherein the voltage regulating unit is configured to control a conduction time of the first switch unit and a conduction time of the second switch unit according to the voltage regulation signal; the charge-discharge unit is charged when the first switch unit is reconnected, and the charge-discharge unit is discharged when the second switch unit is reconnected, so as to adjust the voltage of the input end of the light-emitting module.

17. The backlight structure in claim 16, wherein the voltage regulating unit further comprises a driver;
wherein the charge-discharge unit is respectively electrically connected to the first switch unit and the second switch unit, and the second switch unit is further electrically connected to the input end of the light-emitting module; and
wherein the driver is respectively electrically connected to the feedback unit, the first switch unit, and the second switch unit, and configured to control the conduction time of the first switch unit and the conduction time of the second switch unit according to the voltage regulation signal.

18. The backlight structure in claim 17, wherein the charge-discharge unit comprises an inductor, the first switch unit comprises a first transistor, and the second switch unit comprises a second transistor;
wherein one end of the inductor is provided with an input voltage, and another end of the inductor is electrically connected to a drain electrode of the first transistor and a source electrode of the second transistor; a source electrode of the first transistor is grounded, and a drain electrode of the second transistor is electrically connected to the input end of the light-emitting module; and
wherein an input end of the driver is electrically connected to the feedback unit, and an output end of the driver is electrically connected to a gate electrode of the first transistor and a gate electrode of the second transistor respectively.

19. The backlight structure in claim 18, wherein the voltage regulating unit further comprises a first capacitor and a second capacitor; one end of the first capacitor is electrically connected to an end of the inductor far away from the first transistor, and another end is grounded; and one end of the second capacitor is electrically connected to the input end of the light-emitting module, and another end is grounded.

20. The backlight structure in claim 10, wherein the light-emitting module comprises a plurality of light-emitting diodes (LEDs) connected in series.
